(19) United States
(12) Patent Application Publication
(10) Pub. No.: US 2004/0141654 A1
(43) Pub. Date: Jul. 22, 2004

(54) Texture encoding procedure

(76) Inventor: Yi-Yung Jeng, San Jose, CA (US)

Correspondence Address: SKJERVEN MORRILL LLP, 25 METRO DRIVE, SUITE 700, SAN JOSE, CA, 95110, US

(21) Appl. No.: 10/346,736

(22) Filed: Jan. 17, 2003

(51) Int. Cl. G06K 9/36

(52) U.S. Cl. 382/238

(57) ABSTRACT

A texture encoding procedure is presented which helps to reduce the required number of bits utilized to represent a VOP. The data in each VOP is transformed by a discrete cosine transform and then quantized in a quantization procedure. A prediction direction is then determined for each block to be encoded in the VOP based on the gradients of surrounding blocks to the block to be encoded. A DC prediction can then be performed. Whether or not to perform an AC prediction along the same prediction direction is determined for each macroblock in the VOP based a determination that there is a likelihood that the number of bits required to represent to macroblock would be reduced or not.

### BACKGROUND

1. Field of the Invention

The current invention is directed toward encoding of MPEG-4 multi-media data and, in particular, to texture encoding of MPEG-4 multi-media data.

2. Discussion of Related Art

There is great interest in developing techniques for efficient transmission of multi-media data. MPEG-4 is one of the standards designed to facilitate fast and efficient transmission of such data. The MPEG-4 standard is usually considered an object-based encoding system supporting content-based coding of audio, text, image, synthetic or natural video data, multiplexing of coded data, and composition and representation of audio-visual scenes.

An object-based scene is built with individual objects with spatial and temporal relationships. Each of the individual objects can be natural (e.g., recorded video) or artificial (e.g., computer generated objects). The objects may be created in any number of ways, including from a user's video camera, audio-visual recording technologies, computer generation or any other way. Advantages to this approach include the ability to build morphed scenes, for example with animated characters shown in natural scenes or natural characters in animated scenes. Further, splitting the scenes into individual objects can significantly reduce the number of bits required to transmit a completed audio-visual presentation.

With the current demand for access to complete audio-visual information over various network environments, particular attention is paid to methods of reducing the actual amount of digital data required to represent that information. It is expected that future demand for audio-visual data will match or exceed the current demand for networked textual and graphical data.

In general, the MPEG-4 multi-media standard applies well-known video compression techniques which were developed for its predecessor standards MPEG-1 and MPEG-2. A visual scene can be divided into individual video objects, temporally sliced into video object planes (VOPs). Spatial correlation is removed from the VOPs by discrete cosine transformation followed by a visually weighted quantization. Further, motion prediction can be utilized to reduce temporal redundancies.

Predictive coding can be utilized for further compression. Three types of VOPs are encoded under the MPEG-4 standard: intra-coded (I), predictive-coded (P) and bidirectionally predictive coded (B) VOPs. Predictive coding can be utilized to form the P-VOPs and B-VOPs. Motion vectors and shape information can be coded differentially.

There is a need for encoding and decoding procedures for encoding VOPs that reduce the total number of bits required to represent the audio-visual data.

### SUMMARY

In accordance with the present invention, a texture encoding procedure for VOP encoding which provides further compression of individual VOPs is disclosed. In some embodiments, VOPs are encoded by motion encoding, shape encoding and texture encoding. A method of encoding according to the present invention comprises calculating a prediction direction for blocks in a macroblock; calculating a DC prediction for blocks in the macroblock; determining whether an AC prediction should be performed; and performing an AC prediction if it is determined that the AC prediction should be performed.

VOPs include an array of macroblocks, in some embodiments 16×16 macroblocks form a VOP, which are themselves segregated into blocks, typically 8×8 blocks. In some embodiments, there are six (6) 8×8 blocks in each of the 16×16 macroblocks. A texture encoder according to the present invention receives discrete cosine transformed and quantized blocks of data. The first row, first column position (e.g., the (0,0) position of each 8×8 block) of these blocks, then, is commonly referred to as the DC value of the block while other values in the block, which correspond to higher frequency components, are referred to as the AC components.

A horizontal or vertical direction of encoding is determined by the gradient of the DC values of neighboring blocks to the block currently being encoded. For example, in some embodiments, if the difference between the DC values between the block immediately to the left of the block currently being coded and the block immediately above and to the left of the block being encoded is less than the difference between the DC values of the block immediately above and to the left and the block immediately above, then the prediction is vertical. Otherwise the prediction is horizontal. In a vertical prediction, the DC component is predicted from the DC component of the block immediately above the current block. In a horizontal prediction, the DC component is predicted from the DC component of the block immediately to the left.

Once the prediction direction is determined, then the DC prediction is calculated from the block indicated by the prediction direction to the current block being encoded. Once the DC prediction calculation is completed for each block in a macroblock, then the absolute value of all of the either first row or first column elements of each block in the macroblock, depending on the calculated prediction direction of all blocks in a macroblock, is computed. Further, the prediction values for each block in the prediction direction is calculated and the absolute value of the difference between the prediction value and the actual value of each block is summed. In some embodiments, the sum of the absolute value of the differences is less than or equal to the sum of the values, then AC prediction is also performed.

These and other embodiments will be further discussed below with respect to the following figures.

### SHORT DESCRIPTION OF THE FIGURES

FIGS. 1A and 1B illustrate an MPEG-4 transceiver system.

FIGS. 2A and 2B illustrate a virtual object plane (VOP) encoder and VOP decoder of the MPEG-4 transceiver system shown in FIGS. 1A and 1B.

FIG. 3 shows a texture encoder according to the present invention that can be utilized as part of the VOP encoder shown in FIG. 2A.

FIG. 4 illustrates DC encoding according to the present invention of the texture encoder shown in FIG. 3.

FIG. 5 illustrates AC encoding according to the present invention of the texture encoder shown in FIG. 3.

FIG. 6 illustrates encoding of a macroblock according to the present invention.

In the figures, elements having the same or similar function are assigned the same designation.

### DETAILED DESCRIPTION

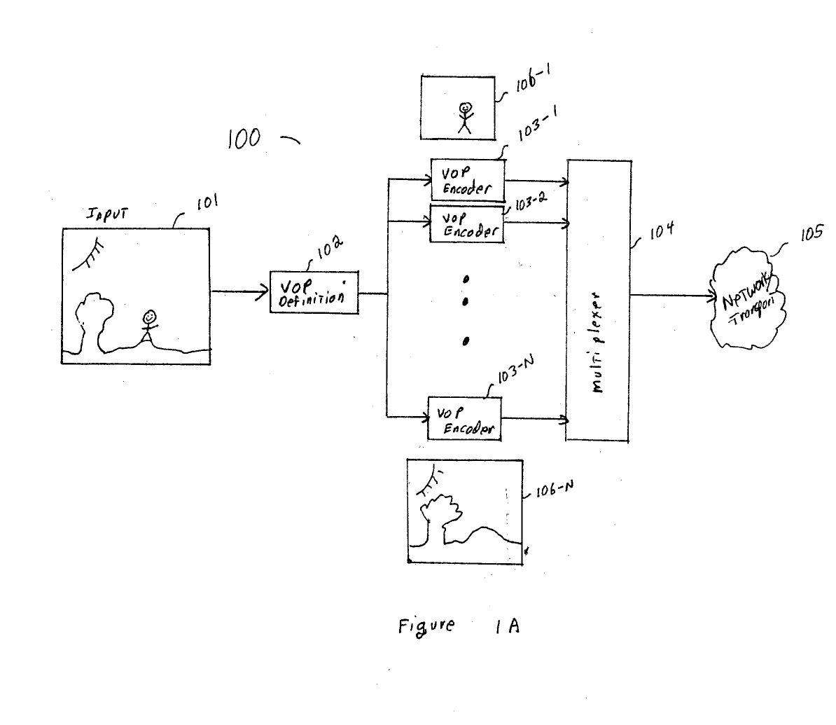

FIG. 1A shows a block diagram of an embodiment of a video transmitter according to the MPEG-4 (Moving Picture Experts Group) standard. The first version of the MPEG-4 standard was released in October of 1998 and became an international standard in November of 1999. The MPEG-4 standard is further described in the ISO/IEC document 14496-2 (hereinafter referred to as the MPEG-4 standard), herein incorporated by reference in its entirety.

The MPEG-4 standard is designed to support a wide range of multi-media applications, including transmission of computer generated or naturally generated video. Applications include telecommunications (e.g., video conferencing) as well as entertainment (e.g., movies, animation, combinations of animation and natural scenes, etc.). As part of the MPEG-4 standard, coding of multi-media material in order to reduce the bit-rate required to transmit high-quality multi-media is necessary in order to fulfill the bandwidth constraints of transport mechanisms such as wireless, internet, or recording media such as magnetic storage or optical storage disks. In accordance with the MPEG-4 standard, audio, video, images, graphics, and other multi-media components can be represented as separate objects and multiplexed to form a scene. Each of the objects utilized to form a scene can be individually encoded in order to exploit the similarities and properties between adjacent time-slices of the objects in order to reduce the bandwidth required to transmit the scene. Further, the ability to individually encode different objects also lends itself to the ability, under the MPEG-4 standard, to individually manipulate different objects of the scene and to add objects or remove objects from the scene.

In FIG. 1A, scene 101 is input to Video Object Plane (VOP) definition 102. VOP definition 102 defines individual VOPs, for example according to whether the object is background material or an object in motion. Since the background object of a scene varies very little between individual time slices, and objects in motion can be better compressed by representing the motion, more efficient transmission can be accomplished by appropriately splitting scene 101 into individual VOPs 106-1 through 106-N. Each of individual VOPs 106-1 through 106-N are input to a corresponding one of VOP encoders 103-1 through 103-N, respectively. The output signals from each of VOP encoders 103-1 through 103-N are multiplexed in multiplexer 104 for output to transport 105. Transport 105 can be a network such as the internet or a storage device such as, for example, a CD-ROM, RW-ROM, DVD, or magnetic disk.

FIG. 1B shows a block diagram of an example MPEG-4 receiver 150. Receiver 150 receives signals from network 105 into de-multiplexer 107. Since signals are encoded in multiplexer 104 (FIG. 1A) in packet format, signals are received and de-multiplexed in de-multiplexer 107 in packet format. Information regarding packet formatting, multiplexing, or de-multiplexing can be found in the MPEG-4 standard. Individual signals corresponding to each of the transmitted VOPs 106-1 thorugh 106-N are input to VOP decoders 108-1 through 108-N, respectively. VOP decoders 108-1 through 108-N decode the signals to reconstruct individual VOPs 111-1 through 111-N, respectively. The signals corresponding to each of VOPs 111-1 through 111-N are input to composition 109 which creates scene 110, corresponding to scene 101.

For any given multi-media presentation, then, each time slice of the presentation, scenes 101, is encoded as shown in transmitter 100, and decoded in receiver 150. Data compression between time slices, i.e. frames, can be accomplished by taking advantage of the similarities between adjacent frames. Often, for most of VOPs 106-1 through 106-N, consecutive frames are nearly identical and only the differences between consecutive frames needs to be encoded. This technique is referred to as interframe coding. Further, the spatial and temporal redundancies of adjacent frames can be utilized in codeing individual frames of VOPs, referred to as intraframe coding.

VOPs 106-1 through 106-N can be an entire frame of scene 101 or a portion of scene 101 and can be encoded as an arbitrary shape. Three different types of VOPs may be used: I-VOPs, P-VOPs or B-VOPs. I-VOPs are self contained VOPs which include information, on its own, for creating that object of scene 101. P-VOPs are predictively coded in order to recreate the VOP for the current frame of scene 101 based on previously encoded VOPs. B-VOPs are bi-directionally coded VOPs which utilize differences between previously encoded VOPs and next encoded VOPs. I-VOPs appear regularly in the data stream since they are required to decode both P-VOPs and B-VOPs. However, I-VOPs require the greatest bandwidths to transmit.

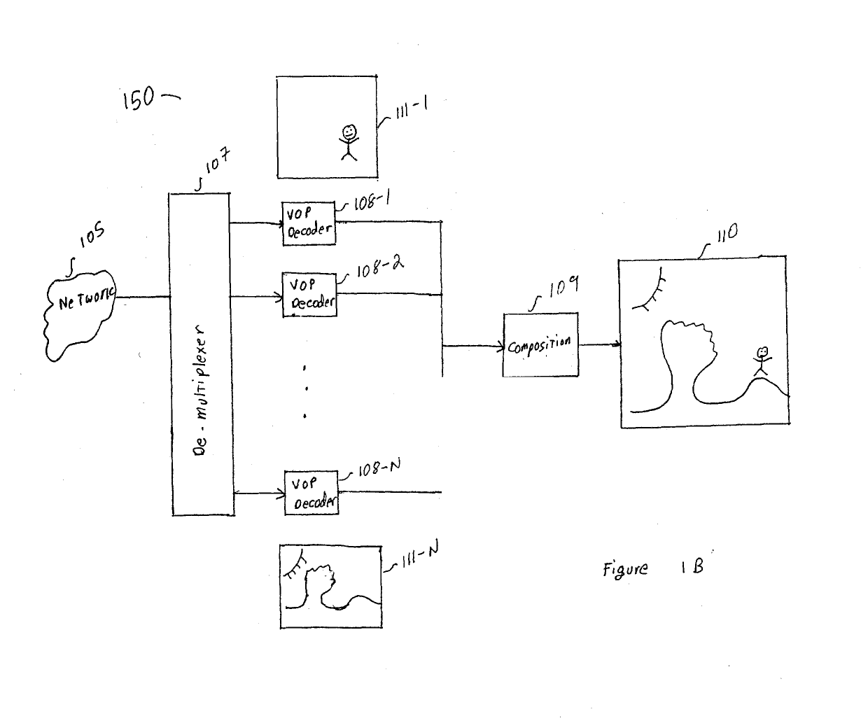

FIG. 2A shows a block diagram of an embodiment of VOP encoder 103-j, an arbitrary one of VOP encoders 103-1 through 103-N of FIG. 1A. VOP definition 102 (FIG. 1A) defines a VOP input to VOP encoder 103-j. Each VOP includes several macroblocks. In some embodiments, a macroblock is a block of 16×16 sets of blocks. Each macroblock is further divided into six blocks, four luminance blocks (Y0, Y1, Y2 and Y3) and two chrominance blocks (U and V). Each of the individual blocks in the sets of blocks is typically of size 8×8 pixels.

VOP 106-j is input to VOP encoder 103-j and encoded in terms of shape, motion and texture. VOP 106-j is input to summer 201. The output signal from summer 201 is input to discrete cosine transformation (DCT) 202. DCT 202 performs two-dimensional discrete cosine transforms on each block, transforming the spatial information in each block of VOP 106-j into the frequency domain. The output signal from DCT 202 is then quantized in quantization 203. Since most of the signal output from summer 201 is in the low frequency domain, higher order coefficients of discrete cosine transformation can be dropped or can be represented within a lower number of quantization levels without noticeable degradation of the signal quality.

The output signal from quantization 203 is input to inverse quantization 206 and inverse DCT 207. Inverse quantization 206 and inverse DCT 207 perform the operation of a decoder in order to reproduce the original signal output from summer 201. The resulting signal is then summed with the output from predictor 210 and stored in block 209. The stored frame in frame store block 209 is utilized in motion estimation 211 to predict the motion of VOP 106-j. Further, shape coding 212 predicts the shape of figures in VOP 106-j. The output signals from motion estimation 211 and shape coding 212 are input to predictor 210 as a prediction of the next frame, which is subtracted from the input signal of VOP 106-j in summer 201. Therefore, the output signal input to texture coding 204 is the background less the motion estimate and the shape coding, which are accomplished separately. The MPEG-4 standard provides further information regarding motion and shape encoding.

The differences between encoding an I-VOP, a B-VOP and a P-VOP is also illustrated in the block diagram of FIG. 2A and is determined by predictor 210. An I-VOP, for example, may have no quantity subtracted in summer 201. I-VOPs are utilized to regain VOPs predicted by B-VOPs and P-VOPs. When VOPs are intercoded, motion estimation is first performed in motion estimation 211 utilizing the I-VOP frame stored in frame store 209 as a reference. A forward motion vector, the difference between the current frame and the frame stored in frame store 209, is then input to DCT 202 to form a coded P-VOP frame. The regenerated P-VOP frame is then restored in frame store 209 for use in encoding the next incoming VOP frame. Encoding B-VOPs is similar to encoding P-VOPs except that B-VOPs are not reconstructed and stored in frame store 209.

The output signals from texture coding 204, motion estimation 211 and shape coding 212 are input to video multiplexer 205. The output signal from video multiplexer 205 is a variable length packet based bit stream as described in the MPEG-4 standard. As shown in FIG. 1A, the bit streams associated with each of VOP encoders 103-1 through 103-N are multiplexed in multiplexer 104 into a larger packet based bit stream as described in the MPEG-4 standard.

FIG. 2B shows a block diagram of a VOP decoder 108-j, which is an arbitrary one of VOP decoders 108-1 through 108-N. De-multiplexer 250 receives the packet signal corresponding to VOP 111-j from demultiplexer 107. Signals are then directed to each of shape decoding 251, motion decoding 252, and texture decoding 253. Shape decoding 251, motion decoding 252 and texture decoding 253 then output signals which are input to motion compensation 254. Motion compensation 254, utilizing the previous VOP stored in block 255, produces a VOP signal which is input to VOP reconstruction 256. Motion compensation 254 also provides inverse quantization and inverse DCT. VOP reconstruction 256 then reconstructs the VOP.

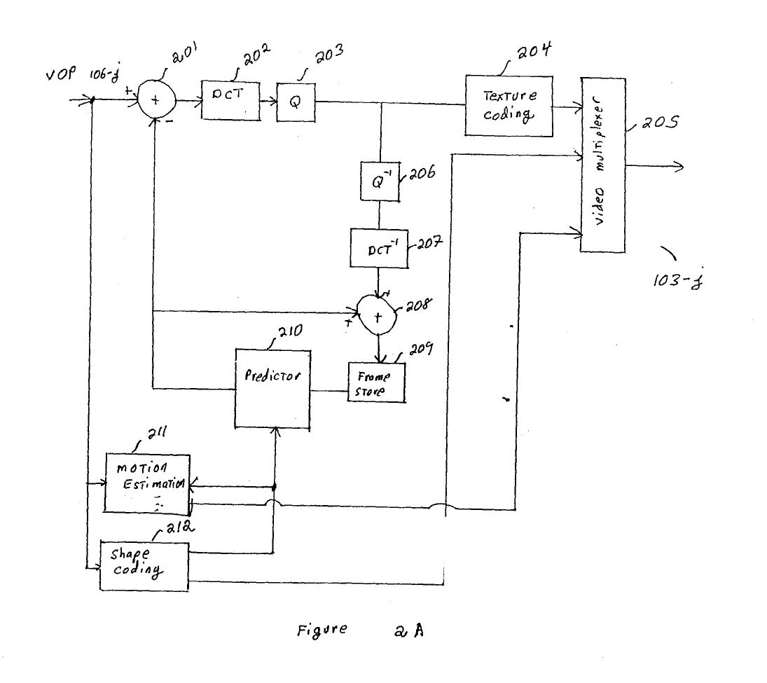

FIG. 3 illustrates an embodiment of texture encoder 204 according to the present invention. Quantization 203 receives the DCT coefficients produced in DCT block 202 (FIG. 2A). As discussed above, DCT 202 transforms the spatial VOP image into the frequency domain. The DCT coefficients can be designated as F[v][u] for each block in the VOP. Any one of several quantization methods can be utilized according to the MPEG-4 standard. For example, if the quantization type is “first quantization method”, then a look-up table is utilized to implement the division of the weighting matrices. There also may be different weighting matrices for intra macro blocks (I-VOPs) as opposed to Inter Macro Blocks (P-VOPs). Another look-up-table is then utilized to determine the actual quantization. In some embodiments, if the current VOP is an I- or P-VOP, then the quantized coefficients of the first row of Blocks 2, 3, 4 and 5 in each Macro Block can be stored in a memory, which can be DRAM, SDRAM, or any other form of memory, for later retrieval.

The output signal from quantization 203, QF[v][u], is input to DC&AC prediction 301. DC&AC prediction 301, according to the present invention, adaptively encodes a current block of the VOP based on comparisons of the horizontal and vertical gradients around the block to be encoded. Encoding is performed in a direction such as to reduce the number of overall bits required to represent the various blocks. In accordance with the present invention, a prediction direction is first determined for each block and DC prediction is first accomplished on a block-by-block basis. Finally, AC prediction is utilized in each block based on a determination of whether AC prediction will reduce the number of overall bits required to represent each macroblock.

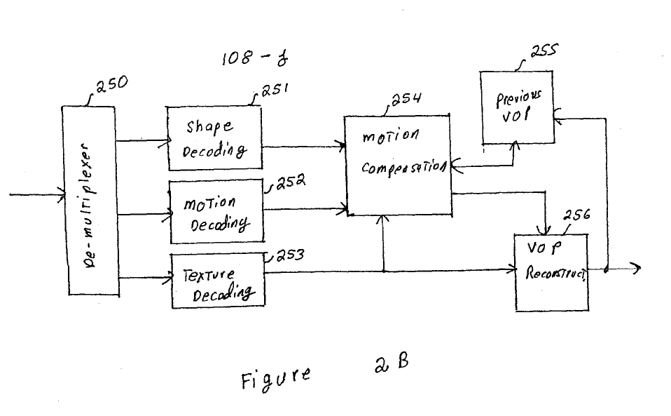

FIG. 4 illustrates the initial DC prediction encoding of a current block, for example X, based on the values in blocks surrounding the current block. The blocks are arranged in order of the displayed image (i.e., in order of the portion of the scene that is being represented by the block). Current block X, the block currently being encoded by texture encoder 204, is surrounded by left block A, above-left block B, and above block C, which is immediately above block X. The quantized DC values of the previously encoded blocks A, B and C, i.e. the first row, first column values of the DCT transformed block, are utilized to determine from which block adaptive prediction is done. The first row, first column position of the DCT transformed block is referred to as the DC position since this is the zero frequency component in the transformation. The remaining values in the 8×8 block are coefficients for different frequencies and are referred to as the AC values, with the most important values being in either the first row or the first column of the block.

As shown in FIG. 4, the value QF_{X}[0][0], the DC value of the X block, is predicted either from the DC position of block A or block C, depending on the previously encoded DC values of blocks A, B and C. For example, if the gradient in the DC value between block A and block B is less than the gradient between block B and block C, then the prediction is done from block C. Otherwise, the prediction is done from block A. Therefore:

If (|F_{A}[0][0]−F_{B}[0][0]|<|F_{B}[0][0]−F_{C}[0][0]|) then

predict from block C else

predict from block A.

If any of the blocks A, B or C are outside of the VOP boundary, or the video packet boundary, or they do not belong to an intra coded macroblock, then their QF[0][0] values can be set to an arbitrarily high value, such as 2^{(bits}^{_{—}}^{per}^{_{—}}^{pixel+2)}, for example, and used to compute the prediction values.

If the prediction is from block C, then

PQF_{X}[0][0] is set to QF_{X}[0][0]−QF_{C}[0][0].

Otherwise,

PQF_{X}[0][0] is set to QF_{X}[0][0]−QF_{A}[0][0].

The difference between QF and F involves normalization by a value dc_scaler. The constant dc_scaler is set in response to the quantization level. The larger the quantization level, the higher the value of dc_scalar, and the lower is the quality of the image representation. Additionally, the dc_scalar value can be different for luminance blocks and chrominance blocks. Further discussion of the dc_scalar is included in the MPEG-4 standard.

The prediction process can be independently repeated for every block of a macroblock using the appropriate immediately horizontally adjacent block A and immediately vertically adjacent block C. In FIG. 4, for example, block Y can be encoded using blocks X, C and D in place of A, B and C, respectively. DC predictions are performed similarly for the luminance and each of the two chrominance components.

In accordance with the present invention, adaptive AC prediction is utilized for a macroblock of blocks if it is beneficial to do so. In some embodiments, a flag (ac_pred_flag) can be set to indicate that AC predictions are to be performed. In some embodiments, both DC and AC predictions can be performed. In order to determine whether AC predictions should be performed, the quantized values in the first row and the first column of each block of a macroblock can be stored. In some embodiments, the first rows are stored in a DRAM and the first columns are stored in a buffer. In some embodiments, only the first column from blocks 1, 3, 4 and 5 (Y1, Y3, U and V) and the first rows from blocks 2, 3, 4, and 5 (Y2, Y3, U and V) need to be stored for future reference.

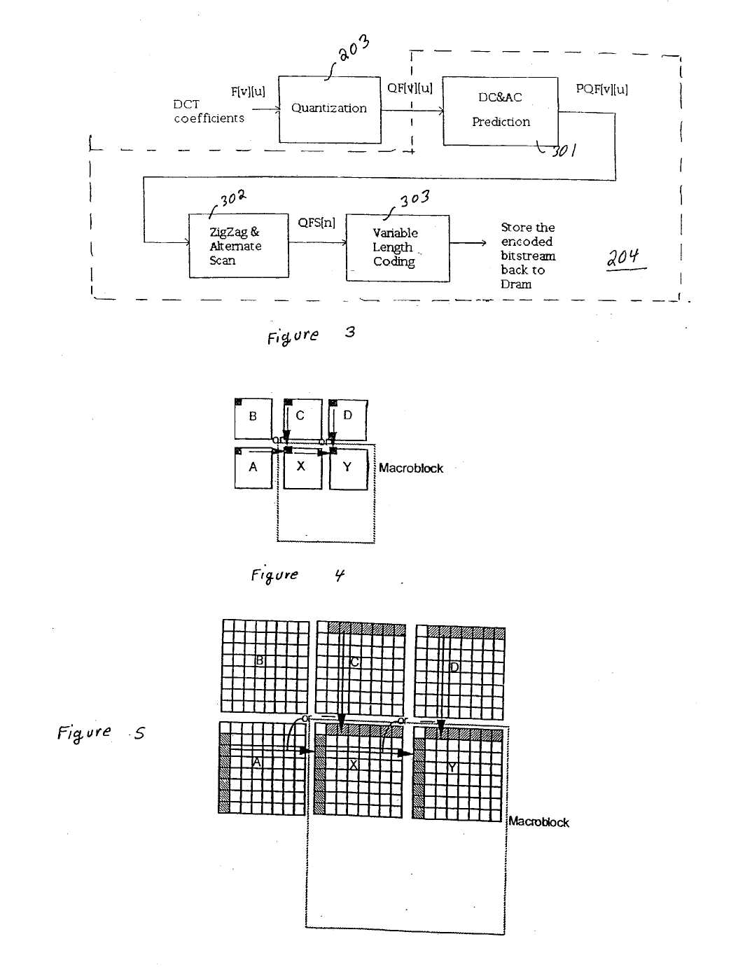

As shown in FIG. 5, the predictions for the current block X can utilize the coefficients from the first row of block C or the first column of block A. On a block-by-block basis, the direction prediction utilized in the DC prediction is also utilized in the AC prediction. Therefore, the prediction for each block is independent of the prediction for any of the previously encoded blocks.

In some embodiments, to compensate for differences in the quantization of previous horizontally adjacent or vertically adjacent blocks utilized in the AC prediction of the current block, scaling of prediction coefficients may be utilized. Therefore, the prediction can be modified so that the predictor is scaled by the ratio of the current quantization stepsize and the quantization stepsize of the predictor block. Therefore, if block A was selected as the predictor for the current block X, then

PQF_{X}[0][i]=QF_{X}[0][i]−QF_{A}[0][i]*QP_{A}/QP_{X} for i=1 to 7,

assuming that each block is an 8×8 block. If block C was selected as the predictor for the current block X, then the first row of block C is utilized to predict the first row of Block X:

PQF_{X}[i][0]=QF_{X}[i][0]−QF_{C}[i][0]*QP_{C}/QP_{X} for i=1 to 7,

again assuming that each block is an 8×8 block. If the prediction block (block A or block C if the current block is block X) is outside of the boundary of the VOP or the video packet, then all the prediction coefficients of that block are assumed to be zero.

Whether or not AC prediction is utilized can be determined based on the relationship between the values of the AC predicted values and the unpredicted values. If a sum of the absolute values of the unpredicted values for an entire macroblock is greater than the sum of the difference between the unpredicted values and the predicted values for that macroblock, then it is likely that utilizing AC prediction will result in a lower bit count for the encoded data and that AC prediction flag ac_pred_flag is set and AC prediction done. Otherwise, the ac-pred-flag should not be set and the AC prediction not done.

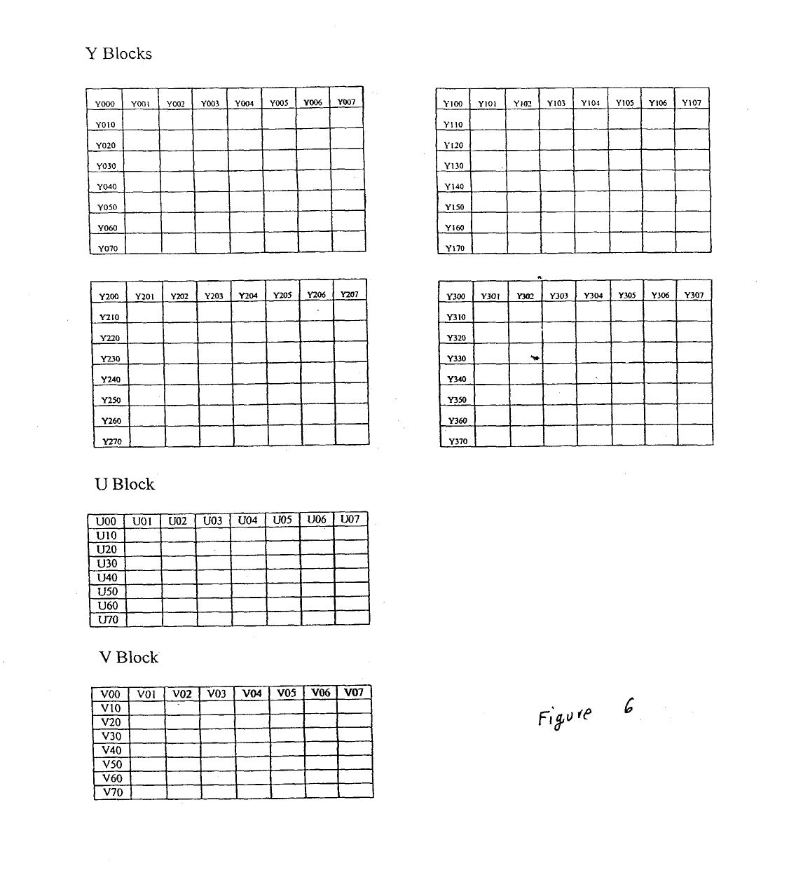

FIG. 6 illustrates the determination of whether AC prediction is done or not with a macroblock having four luminance blocks Y0, Y1, Y2, and Y3, and two chrominance blocks U and V. In practice, the first column quantized coefficients of blocks Y1, Y3, U and V (Blocks 1, 3, 4 and 5 of the macroblock) and the first row quantized coefficients of blocks Y2, Y3, U and V (blocks 2, 3, 4 and 5) of each I- or P- VOP macroblock can be stored. In some embodiments, columns are stored in a buffer and rows are stored in a DRAM. The first positions for each block can then be read out of memory, either the buffer or DRAM, and utilized to determine the direction of prediction as described above.

Based on the prediction directions, the absolute values of the row or column values of each block are summed. Further, the absolute value of the difference between these row or column values and the prediction values are summed. Comparing these two numbers, if the sum of absolute values of the difference between the first column or row quantizied coefficients and the co-site horizontal or vertical prediction data of each block in the macro block is smaller, then the coding efficiency of using DC and AC prediction will be better than that utilizing DC prediction alone and the ac_pred_flag for that macroblock is set. At the same time, if the ac_pred_flag is set, then the corresponding rows or columns can be replaced by the prediction values.

TABLE I

| Block | Prediction direction | Prediction Data |
|---|---|---|
| 0 (Y0) | Horizontal | PY0₀ᵢ, i = 1 through 7 |
| 1 (Y1) | Vertical | PY1ᵢ₀, i = 1 through 7 |
| 2 (Y2) | Vertical | PY2ᵢ₀, i = 1 through 7 |
| 3 (Y3) | Horizontal | PY3₀ᵢ, i = 1 through 7 |
| 4 (U) | Horizontal | PU₀ᵢ, i = 1 through 7 |
| 5 (V) | Horizontal | PV₀ᵢ, i = 1 through 7 |

Table I shows an example utilizing the macroblock shown in FIG. 6, of a possible set of prediction directions and the resulting prediction data. Given the prediction directions shown in the example of Table I, the values QY00i, i=0 through 7; QY1i0, i=0 through 7; QY2i0, i=0 through 7; QY30i, i=0 through 7; QU0i, i=0 through 7; and QV0i, i=0 through 7 are stored either in a buffer or a DRAM. The sum of the absolute values is then computed:

$$\begin{matrix}MB\_ABS \_SUM = {\sum }_{i = 1}^{7} ( \vert {QY}_{00 i} \vert + \vert {QY}_{1 i0} \vert + \vert {QY}_{2 i0} \vert + \vert {QY}_{30 i} \vert + \\ \vert {U}_{0 i} \vert + \vert {V}_{0 i} \vert ) .\end{matrix}$$

Further, the sum difference of all of the predicted values and the quantized values is computed:

$$\begin{matrix}SUM\_ABS \_DIFF = {\sum }_{i = 1}^{7} ( \vert {QY}_{00 i} - {PY}_{00 i} \vert + \vert {QY}_{1 i0} - {PY}_{1 i0} \vert + \\ \vert {QY}_{2 i0} - {PY}_{2 i0} \vert + \vert {QY}_{30 i} - {PY}_{30 i} \vert + \\ \vert {QU}_{0 i} - {PU}_{0 i} \vert + \vert {QV}_{0 i} - {PV}_{0 i} \vert )\end{matrix}$$

If MB_ABS_SUM≧SUM_ABS-DIFF, then the ac prediction method will likely result in reducing the bit count for the fully coded data. Under that condition, the ac-pred-flag is set and the AC prediction is performed.

The output signal from DC&AC prediction 301, PF[v][u], is then input to scan 302. Scan 302 outputs a serial stream of data PS[n]. For each block, the following scan type determinations can be determined: if the ac-pred-flag is set and the prediction direction is horizontal, then the alternate vertical scan pattern can be utilized; if the ac_pred_flag is set and the prediction is vertical, then the alternate horizontal scan pattern can be utilized; if the ac_pred_flag is not set, then the zigzag scan pattern can be utilized. Depending on the ac_pred_flag, the data output from scan 302 can be either the data from the macroblock buffer or the result of the data minus the prediction data in the order of the scan pattern.

The output signal from scan 302 is then input to variable length coding 303. The variable length coding is accomplished according to the MPEG-4 standard and the resulting data stream can be stored in DRAM for final input to multiplexer 205 (FIG. 2A). Variable length coding 303 can utilize multiplexers according to the VLC look up tables of the MPEG-4 standard to encode the data. Values for RUN and LEVEL can be calculated and code-words can be selected and packed into 64 bit data packets.

The above description is for example only. One skilled in the art may find alternate embodiments of the invention which would fall within the spirit and scope of this invention. As such, this invention is limited only by the following claims.

I claim:

1. A method of encoding video data, comprising:
determining a prediction direction for a block of data of a video object plane;
performing a DC prediction in the prediction direction for the block of data;
determining whether an AC prediction should be performed for the block of data; and
performing the AC prediction for the block of data if the AC prediction should be performed.

2. The method of claim 1, wherein the block of data is one of at least one block of data of a macroblock, the macroblock being one of at least one macroblock of data that represents the video object plane.

3. The method of claim 2, wherein each macroblock of data representing the video object plane includes luminance blocks and chrominance blocks.

4. The method of claim 3, wherein each macroblock of data representing the video object plane includes four luminance blocks and two chrominance blocks.

5. The method of claim 4, wherein the video object plane is represented by a 16 by 16 array of macroblocks.

6. The method of claim 5, wherein each of the luminance blocks and chrominance blocks is an 8 by 8 array of digital data.

7. The method of claim 2, further including
transforming data of the video object plane to form transformed data; and
quantizing the transformed data to obtain the block of data of the at least one macroblock representing the video object plane.

8. The method of claim 7, wherein transforming the data includes performing a discrete cosine transform on data of the video object plane;

9. The method of claim 1, wherein determining a prediction direction for the block includes
calculating a first difference value between DC values of a left adjacent block and a left-above block;
calculating a second difference value between DC values of the left-above block and an above block;
setting the prediction direction to predict from the above block if the second value is greater than the first value; and
setting the prediction direction to predict from the left adjacent block if the second value is less than the first value.

10. The method of claim 9, wherein the DC value of the left adjacent block is set to an arbitrarily high value if the left adjacent block is not of a macroblock of the video object plane, the DC value of the left-above block is set to an arbitrarily high value if the left-above block is not of a macroblock of the video object plane, and the DC value of the above block is set to an arbitrarily high value if the above-block is not of a macroblock of the video object plane.

11. The method of claim 9, wherein the DC value of the left adjacent block is set to an arbitrarily high value if the left adjacent block is not of a macroblock of the video packet, the DC value of the left-above block is set to an arbitrarily high value if the left-above block is not of a macroblock of the video object plane, and the DC value of the above block is set to an arbitrarily high value if the above-block is not of a macroblock of the video packet.

12. The method of claim 1, wherein performing a DC prediction includes calculating a prediction value from the difference between a DC value of the block and a DC value of a left-adjacent block if the prediction direction is from the left adjacent block or from the difference between the DC value of the block and a DC value of an above block if the prediction direction is from the above block.

13. The method of claim 2, wherein determining whether the AC prediction should be performed for the block of data includes
calculating prediction values along the prediction direction for each block of the macroblock that includes the block;
calculating a sum of the absolute value of the prediction values along the prediction direction of each block of the macroblock;
calculating a sum of the absolute difference between the values in each block and the prediction values in the prediction direction for each block of the macroblock that includes the block; and
determining that the AC prediction should be performed if the sum of the absolute values is greater than or equal to the sum of the absolute difference.

14. The method of claim 13, wherein performing the AC prediction includes utilizing the prediction values for the block.

15. A method of encoding a video object plane, comprising:
transforming data of the video object plane to form transformed data;
quantizing the transformed data to form quantized data;
determining a prediction direction for each block of data of the quantized data;
performing a DC prediction in the prediction direction for each block of data;
determining whether an AC prediction should be performed for each macroblock of the block of data, each macroblock including at least one block of data of the quantized data; and
performing the AC prediction for blocks in each macroblock where it is determined that the AC prediction should be performed.

16. The method of claim 15, wherein transforming the data includes performing a discrete cosine transformation of the data of the video object plane.

17. The method of claim 15, wherein determining a prediction direction for each block includes
calculating a first difference value between DC values of a left adjacent block and a left-above block for each block;
calculating a second difference value between DC values of the left-above block and an above block for each block;
setting the prediction direction of each block to predict from the above block if the second value is greater than the first value; and
setting the prediction direction of each block to predict from the left adjacent block if the second value is less than the first value.

18. The method of claim 17, wherein the DC value of the left adjacent block is set to an arbitrarily high value if the left adjacent block is not of a macroblock of the video object plane, the DC value of the left-above block is set to an arbitrarily high value if the left-above block is not of a macroblock of the video object plane, and the DC value of the above block is set to an arbitrarily high value if the above-block is not of a macroblock of the video object plane.

19. The method of claim 17, wherein the DC value of the left adjacent block is set to an arbitrarily high value if the left adjacent block is not of a macroblock of the video object plane, the DC value of the left-above block is set to an arbitrarily high value if the left-above block is not of a macroblock of the video packet, and the DC value of the above block is set to an arbitrarily high value if the above-block is not of a macroblock of the video packet.

20. The method of claim 15, wherein performing a DC prediction for each block includes calculating a prediction value for each block from the difference between a DC value of the block and a DC value of a left-adjacent block if the prediction direction is horizontal for or from the difference between the DC value of the block and a DC value of an above block if the prediction direction is vertical.

21. The method of claim 15, wherein determining whether the AC prediction should be performed for each block of data includes
calculating prediction values along the prediction direction for each block of a macroblock;
calculating a sum of the absolute value of the prediction values along the prediction direction of each block of the macroblock;
calculating a sum of the absolute difference between the values in each block and the prediction values in the prediction direction for each block of the macroblock that includes the block; and
determining that the AC prediction should be performed for each block of the macroblock if the sum of the absolute values is greater than or equal to the sum of the absolute difference.

22. The method of claim 13, wherein performing the AC prediction includes utilizing the prediction values for the block.
